(19) United States
(12) Patent Application Publication
(10) Pub. No.: US 2026/0129392 A1
(43) Pub. Date: May 7, 2026

(54) SPATIAL AUDIO RENDERING

(71) Applicant: Nokia Technologies Oy, Espoo (FI)

(72) Inventors: Jussi Artturi Leppänen, Tampere (FI); Sujeet Shyamsundar Mate, Tampere (FI); Arto Juhani Lehtiniemi, Lempäälä (FI)

(21) Appl. No.: 19/118,022

(22) PCT Filed: Sep. 13, 2023
(86) PCT No.: PCT/EP2023/075155

§ 371 Date: Apr. 3, 2025

(30) Foreign Application Priority Data
Oct. 10, 2022 (GB) 2214902.5

(51) Int. Cl. H04S 7/00

(52) U.S. Cl. CPC H04S 7/301

(57) ABSTRACT

A method, including: generating a bitstream configured to define a six-degrees of freedom rendering, the bitstream including: a six degrees of freedom audio scene; and information configured to define at least one rendering mode, the information including: an identifier configured to identify the at least one rendering mode; and at least one rendering modification associated with the at least one rendering mode to be applied by a renderer when rendering the six degrees of freedom audio scene when the at least one rendering mode is selected at the renderer.

### FIELD

The present application relates to apparatus and methods for spatial audio rendering which employ selectable rendering modes, but not exclusively for spatial audio rendering which employ selectable rendering modes in augmented reality and/or virtual reality apparatus.

### BACKGROUND

Spatial audio capture approaches attempt to capture an audio environment such that the audio environment can be perceptually recreated to a listener in an effective manner and furthermore may permit a listener to move and/or rotate within the recreated audio environment. For example in some systems (3 degrees of freedom—3DoF) the listener may rotate their head and the rendered audio signals reflect this rotation motion. In some systems (3 degrees of freedom plus—3DoF+) the listener may ‘move’ slightly within the environment as well as rotate their head and in others (6 degrees of freedom—6DoF) the listener may freely move within the environment and rotate their head.

Rendering is a process wherein the captured audio signals (or transport audio signals derived from the captured audio signals) and parameters are processed to produce a suitable output for outputting to a listener, for example via headphones or loudspeakers or any suitable audio transducer.

### SUMMARY

There is provided according to a first aspect a method comprising: generating a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

The information comprising at least one rendering modification to be applied by a renderer when rendering an output audio signal from the six degrees of freedom audio stream when the at least one rendering mode is selected at the renderer may comprise at least one modification parameter, the at least one modification parameter being configured to control a modification of at least one rendering process at the renderer.

The at least one modification parameter may be further configured to control a modification of at least one default rendering process at the renderer, wherein the default rendering process may be applied by the renderer when rendering the six degrees of freedom audio scene when the at least one rendering mode is not selected.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

Generating a bitstream configured to define a six-degrees of freedom rendering may comprise at least one of: receiving the information in an encoder input file format and generating an encoded MPEG-I format bitstream to be combined with an encoded six degrees of freedom audio scene bitstream; and obtaining the information in an MPEG-I format and combining the information with an encoded six degrees of freedom audio scene bitstream.

According to a second aspect there is provided a method, comprising: obtaining a bitstream configured to define a six-degrees of freedom rendering, the bitstream comprising a six degrees of freedom audio scene; obtaining information configured to define at least one rendering mode, the information comprising: an identifier configured to identify the at least one rendering mode; and at least one rendering modification associated with the at least one rendering mode; obtaining information identifying a desired rendering mode; rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and controlling the outputting of the at least two output audio signals.

The information comprising the at least one rendering modification associated with the at least one rendering mode may comprise at least one modification parameter, wherein rendering the bitstream to generate at least two output audio signals from the bitstream may comprise rendering the bitstream based on the at least one modification parameter controlling a modification of at least one rendering process.

The at least one modification parameter may be configured to control a modification of at least one default rendering process, wherein rendering the bitstream to generate at least two output audio signals from the bitstream configured to define a six-degrees of freedom audio rendering may comprise rendering the bitstream by applying the default rendering process when the at least one rendering mode is not selected.

The method may further comprise: determining the default rendering process based on: the bitstream configured to define a six-degrees of freedom rendering; and at least one renderer defined value.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

Obtaining information configured to define at least one rendering mode may comprise obtaining at least one predetermined information prior to the obtaining of the bitstream.

Obtaining information configured to define at least one rendering mode may comprise receiving at least one further at least one information configured to define at least one rendering mode, wherein the received at least one further at least one information configured to define at least one rendering mode supersedes the at least one predetermined information configured to define at least one rendering mode.

The bitstream may further comprise the information configured to define the at least one rendering mode wherein obtaining information configured to define at least one rendering mode may comprise obtaining the information from the bitstream.

The information configured to define the at least one rendering mode may be an encoder input format.

Obtaining information identifying a desired rendering mode may comprise obtaining an input from a user interface identifying the desired rendering mode.

According to a third aspect there is provided an apparatus comprising means configured to: generate a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

The information comprising at least one rendering modification to be applied by a renderer when rendering an output audio signal from the six degrees of freedom audio stream when the at least one rendering mode is selected at the renderer may comprise at least one modification parameter, the at least one modification parameter being configured to control a modification of at least one rendering process at the renderer.

The at least one modification parameter may be further configured to control a modification of at least one default rendering process at the renderer, wherein the default rendering process may be applied by the renderer when rendering the six degrees of freedom audio scene when the at least one rendering mode is not selected.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

The means configured to generate a bitstream configured to define a six-degrees of freedom rendering may be configured to perform at least one of: receive the information in an encoder input file format and generating an encoded MPEG-I format bitstream to be combined with an encoded six degrees of freedom audio scene bitstream; and obtain the information in an MPEG-I format and combining the information with an encoded six degrees of freedom audio scene bitstream.

According to a fourth aspect there is provided an apparatus comprising means configured to: obtain a bitstream configured to define a six-degrees of freedom rendering, the bitstream comprising a six degrees of freedom audio scene; obtain information configured to define at least one rendering mode, the information comprising: an identifier configured to identify the at least one rendering mode; and at least one rendering modification associated with the at least one rendering mode; obtain information identifying a desired rendering mode; render the bitstream to generate at least two output audio signals from the bitstream configured to define a six-degrees of freedom audio rendering, wherein the means configured to render is modified based on the at least one rendering modification associated with a selected one of the at least one rendering mode, the selected one of the at least one rendering mode being selected based on the information identifying the desired rendering mode; and control the outputting of the at least two output audio signals.

The information comprising the at least one rendering modification associated with the at least one rendering mode may comprise at least one modification parameter, wherein the means configured to render the bitstream to generate at least two output audio signals from the bitstream may be configured to render the bitstream based on the at least one modification parameter controlling a modification of at least one rendering process.

The at least one modification parameter may be configured to control a modification of at least one default rendering process, wherein the means configured to render the bitstream to generate at least two output audio signals from the bitstream configured to define a six-degrees of freedom audio rendering may be configured to render the bitstream by applying the default rendering process when the at least one rendering mode is not selected.

The means may be further configured to: determine the default rendering process based on: the bitstream configured to define a six-degrees of freedom rendering; and at least one renderer defined value.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

The means configured to obtain information configured to define at least one rendering mode may be configured to obtain at least one predetermined information prior to the obtaining of the bitstream.

The means configured to obtain information configured to define at least one rendering mode may be configured to receive at least one further at least one information configured to define at least one rendering mode, wherein the received at least one further at least one information configured to define at least one rendering mode supersedes the at least one predetermined information configured to define at least one rendering mode.

The bitstream may further comprise the information configured to define the at least one rendering mode wherein the means configured to obtain information configured to define at least one rendering mode may be caused to obtain the information from the bitstream.

The information configured to define the at least one rendering mode may be an encoder input format.

The means configured to obtain information identifying a desired rendering mode may be configured to obtain an input from a user interface identifying the desired rendering mode.

According to a fifth aspect there is provided an apparatus comprising at least one processor and at least one memory storing instructions that, when executed by the at least one processor, cause the system at least to perform: generating a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

The information comprising at least one rendering modification to be applied by a renderer when rendering an output audio signal from the six degrees of freedom audio stream when the at least one rendering mode is selected at the renderer may comprise at least one modification parameter, the at least one modification parameter being configured to control a modification of at least one rendering process at the renderer.

The at least one modification parameter may be further configured to control a modification of at least one default rendering process at the renderer, wherein the default rendering process may be applied by the renderer when rendering the six degrees of freedom audio scene when the at least one rendering mode is not selected.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

The apparatus caused to perform generating a bitstream configured to define a six-degrees of freedom rendering may be caused to perform at least one of: receiving the information in an encoder input file format and generating an encoded MPEG-I format bitstream to be combined with an encoded six degrees of freedom audio scene bitstream; and obtaining the information in an MPEG-I format and combining the information with an encoded six degrees of freedom audio scene bitstream.

According to a sixth aspect there is provided an apparatus comprising at least one processor and at least one memory storing instructions that, when executed by the at least one processor, cause the system at least to perform: obtaining a bitstream configured to define a six-degrees of freedom rendering, the bitstream comprising a six degrees of freedom audio scene; obtaining information configured to define at least one rendering mode, the information comprising: an identifier configured to identify the at least one rendering mode; and at least one rendering modification associated with the at least one rendering mode; obtaining information identifying a desired rendering mode; rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and controlling the outputting of the at least two output audio signals.

The information comprising the at least one rendering modification associated with the at least one rendering mode may comprise at least one modification parameter, wherein the apparatus caused to perform rendering the bitstream to generate at least two output audio signals from the bitstream may be further caused to perform rendering the bitstream based on the at least one modification parameter controlling a modification of at least one rendering process.

The at least one modification parameter may be configured to control a modification of at least one default rendering process, wherein the apparatus caused to perform rendering the bitstream to generate at least two output audio signals from the bitstream configured to define a six-degrees of freedom audio rendering may be caused to perform rendering the bitstream by applying the default rendering process when the at least one rendering mode is not selected.

The apparatus may be further caused to perform determining the default rendering process based on: the bitstream configured to define a six-degrees of freedom rendering; and at least one renderer defined value.

The at least one modification parameter may comprise at least one of: a reverberation modification configured to selectively enable reverberation for at least one audio source within the six degrees of freedom audio scene; a reflections modification configured to selectively enable reflections for at least one audio source within the six degrees of freedom audio scene; an occlusion modification configured to selectively enable occlusions for at least one audio source within the six degrees of freedom audio scene; a diffraction modification configured to selectively enable diffraction for at least one audio source within the six degrees of freedom audio scene; a heterogenous extent modification configured to selectively enable heterogenous propagation for at least one audio source within the six degrees for freedom audio scene; a homogenous extent modification configured to selectively enable homogenous propagation for at least one audio source within the six degrees for freedom audio scene; a portals modification configured to selectively enable portals for at least one audio source within the six degrees for freedom audio scene; a distance gain modification configured to selectively enable distance gains for at least one audio source within the six degrees for freedom audio scene; and a doppler modification configured to selectively enable doppler effects for at least one audio source within the six degrees for freedom audio scene.

The at least one modification parameter may comprise at least one of: a disable effect modification configured to disable at least one rendering process; an attenuate effect modification configured to attenuate at least one rendering process; and an enhance effect modification configured to enhance at least one rendering process.

The apparatus caused to perform obtaining information configured to define at least one rendering mode may be caused to perform obtaining at least one predetermined information prior to the obtaining of the bitstream.

The apparatus caused to perform obtaining information configured to define at least one rendering mode may be caused to perform receiving at least one further at least one information configured to define at least one rendering mode, wherein the received at least one further at least one information configured to define at least one rendering mode supersedes the at least one predetermined information configured to define at least one rendering mode.

The bitstream may further comprise the information configured to define the at least one rendering mode wherein the apparatus caused to perform obtaining information configured to define at least one rendering mode may be caused to perform obtaining the information from the bitstream.

The information configured to define the at least one rendering mode may be an encoder input format.

The apparatus caused to perform obtaining information identifying a desired rendering mode may be caused to perform obtaining an input from a user interface identifying the desired rendering mode.

According to a seventh aspect there is provided an apparatus comprising: generating circuitry configured generate a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

According to an eighth aspect there is provided an apparatus comprising: obtaining circuitry configured to obtain a bitstream configured to define a six-degrees of freedom rendering, the bitstream comprising a six degrees of freedom audio scene; obtain information configured to define at least one rendering mode, the information comprising: an identifier configured to identify the at least one rendering mode; and at least one rendering modification associated with the at least one rendering mode; obtaining circuitry configured to obtain information identifying a desired rendering mode; rendering circuitry configured to render the bitstream to generate at least two output audio signals from the bitstream configured to define a six-degrees of freedom audio rendering, wherein the rendering circuitry configured to render is configured to modify the rendering based on the at least one rendering modification associated with a selected one of the at least one rendering mode, the selected one of the at least one rendering mode being selected based on the information identifying the desired rendering mode; and controlling circuitry configured to control the outputting of the at least two output audio signals.

According to a ninth aspect there is provided a computer program comprising instructions [or a computer readable medium comprising instructions] for causing an apparatus caused to perform at least the following: generating a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

According to a tenth aspect there is provided a computer program comprising instructions [or a computer readable medium comprising instructions] for causing an apparatus caused to perform at least the following: obtaining a bitstream configured to define a six-degrees of freedom rendering, the bitstream comprising a six degrees of freedom audio scene; obtaining information configured to define at least one rendering mode, the information comprising: an identifier configured to identify the at least one rendering mode; and at least one rendering modification associated with the at least one rendering mode; obtaining information identifying a desired rendering mode; rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and controlling the outputting of the at least two output audio signals.

According to an eleventh aspect there is provided a non-transitory computer readable medium comprising program instructions for causing an apparatus to perform at least the following: generating a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

According to a twelfth aspect there is provided a non-transitory computer readable medium comprising program instructions for causing an apparatus to perform at least the following: obtaining a bitstream configured to define a six-degrees of freedom rendering, the bitstream comprising a six degrees of freedom audio scene; obtaining information configured to define at least one rendering mode, the information comprising: an identifier configured to identify the at least one rendering mode; and at least one rendering modification associated with the at least one rendering mode; obtaining information identifying a desired rendering mode; rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and controlling the outputting of the at least two output audio signals.

According to a thirteenth aspect there is provided an apparatus comprising: means for generating a bitstream configured to define a six-degrees of freedom rendering, the bitstream comprising: a six degrees of freedom audio scene; and information configured to define at least one rendering mode, the information comprising: an identifier configured to identify the at least one rendering mode; and at least one rendering modification associated with the at least one rendering mode to be applied by a renderer when rendering the six degrees of freedom audio scene when the at least one rendering mode is selected at the renderer.

According to a fourteenth aspect there is provided an apparatus comprising: means for obtaining a bitstream configured to define a six-degrees of freedom rendering, the bitstream comprising a six degrees of freedom audio scene; means for obtaining information configured to define at least one rendering mode, the information comprising: an identifier configured to identify the at least one rendering mode; and at least one rendering modification associated with the at least one rendering mode; means for obtaining information identifying a desired rendering mode; means for rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and means for controlling the outputting of the at least two output audio signals.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows an example audio environment;

FIG. 2 shows a schematic model of rendering room acoustics;

FIG. 3 shows a schematic view of an example implementation of a system of apparatus suitable for implementing some embodiments;

FIG. 4 shows a schematic view of an example playback device as shown in FIG. 3 in further detail according to some embodiments;

FIGS. 5 to 8 show flow diagrams of the operation of playback device as shown in FIG. 3 according to some embodiments;

FIG. 9 shows a flow diagram of the operation of a content creator as shown in FIG. 3 according to some embodiments;

FIG. 10 shows a schematic model of rendering room acoustics such as shown in FIG. 2 employing switchable rendering modes according to some embodiments;

FIG. 11 shows schematic views of apparatus for summarising the embodiments described in detail herein; and

FIG. 12 shows an example device suitable for implementing the apparatus shown in previous figures.

### EMBODIMENTS OF THE APPLICATION

The following describes in further detail suitable apparatus and possible mechanisms for parameterizing and rendering audio scenes.

This examples provided herein describe embodiments relating to virtual reality, augmented reality and 6DoF audio rendering. Furthermore as described in detail herein the embodiments also relate to user selectable modes that affect the 6DoF audio rendering.

The embodiments as described herein are suitable for employing within the MPEG-I standard which is being developed for 6DoF audio rendering for audio scenes. MPEG-I uses the MPEG-H standard for audio waveform compression. MPEG-H also specifies certain user selectable settings which are referred to as presets. The concept as expressed in the following embodiments in further detail is one of employing user selectable playback modes which can alter (and aim to optimize) rendering for certain subjective experience aspects (or operating points), such as emphasis on clarity of dialogue, easy audio localization, etc.

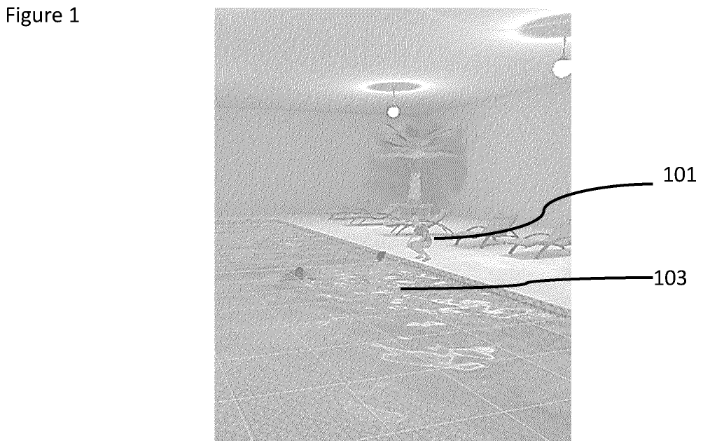

Making sense of a 6DoF VR/AR audio scene as intended by the content creator or as per listener preferences may be difficult if the scene is rendered without taking into account the content creator intent or user preference(s). For example dialogue or conversations in an audio scene may be difficult to understand in a very reverberant space. For example as shown in FIG. 1 a scene located within a swimming pool may result in a listener finding it difficult to try to understand what people 101, 103 are saying when listening from some distance away. The listener can thus find it difficult both in real life and when rendered realistically in 6DoF VR/AR.

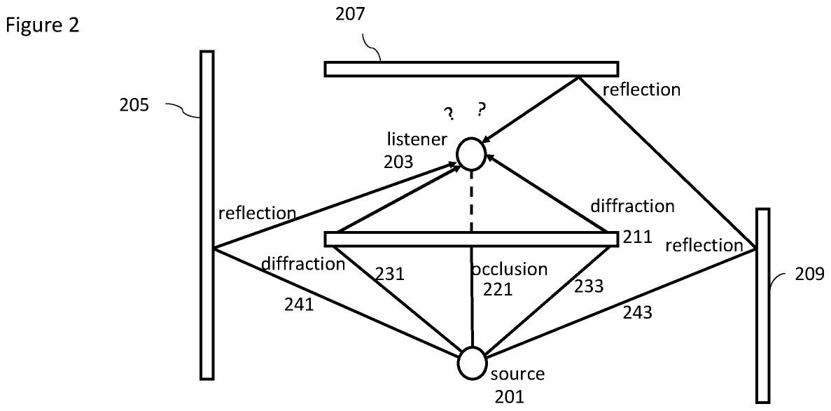

Additionally early reflection effects may cause the listener to be confused with respect to a location of a sound source when the direct path to the source is occluded. This can happen also in real life, for example, in urban areas when the listener is located in a scene, between hard surfaces (such as building walls) and does not have direct line of sight to an audio source. The listener in such a situation hears the reflections off the walls most prominently. This for example is shown in the model of an audio scene shown in FIG. 2. In FIG. 2 the audio source 201 and the listener 203 are located in the scene with a wall 211 blocking the direct line-of-propagation between the audio source 201 and the listener 203. Additionally there is a ‘rear’ wall 207 located behind the listener (from the point of view that the wall 211 is a ‘front’ wall). Additionally there is also shown two side walls 205 and 209 located either side of the audio source 201 and the listener 203. As shown in this example the direct line of propagation 221 is blocked or occulted by the wall 211. The model shows diffracted paths 231 and 223 around the wall 211. Additionally there are shown reflected path 241 from the audio source 201 reflected off wall 205 and reflected path 243 from the audio source 201 reflected off walls 209 and 207 before reaching the listener 203. In this example the listener therefore experiences the audio source as being received from many different directions, none of which being the true one.

Furthermore for novice users, there can be audio scenes that are too busy (in other words have too many sources, or have sources with high levels of reverberation, etc.) and can therefore be confusing and tiring to listen to. For example such complex scenes can require a high cognitive load to fully comprehend and as such produce an effect which tires the listener.

The embodiments as discussed herein enable rendering to be adapted based on listener preferences (and within permitted boundaries set by a content creator or in accordance with content creator intent).

Thus in some embodiments there is introduced additional functionality in the MPEG-I Immersive Audio standard to be able to specify as well as adapt the rendering as preferred by the listener.

This concept as discussed herein in further detail by the following embodiments relates to rendering mode dependent rendering of 6DoF audio scenes where audio rendering is modified according to a (user) selected rendering mode. In some embodiments this can be summarized with respect to the playback or rendering device by the following:
Obtaining a mode (for example from a user of the playback device);
Modifying rendering according to the obtained mode.

The mode obtaining or selection operation as discussed herein in further detail may be caused by the user and thus causes the renderer to operate at different operating points defined by subjective parameters (for example within a dialogue mode, navigation/localization mode etc.). An example of which is that similar to the example shown in FIG. 1 where a user of a playback device (or listener) is experiencing a 6DoF audio scene. The scene comprises two people talking in a highly reverberant swimming hall. The user, finding it difficult to understand the dialogue within in scene can select a dialogue mode from a user interface on the playback device. The selection of the dialogue mode can cause the renderer to lover the reverberation level, thus making the dialogue easier to understand.

In some embodiments this can be further extended within the playback device to the following summary:
Obtaining (possible) mode metadata. The mode metadata comprising rendering mode dependent rendering modification instructions or controls for affecting the rendering of audio signals to the user;
Obtaining a mode (for example from a user of the playback device);
Modify rendering according to the obtained mode and rendering modification instructions.

An example of such embodiments could be one wherein a user of a playback device experiences a 6DoF audio scene. In this example the audio scene is a large house where there is an interesting audio source in the basement. When the scene is rendered in a normal 6DoF mode the user can not accurately determine where the sound is coming from and selects a “navigation mode”. Furthermore a content creator (operating a content creator device), during the creation or designing of the audio scene, has created or defined how the renderer is configured to render the output when operating in the navigation mode. For example the content creator device can be configured to generate and add metadata describing that, in the navigation mode, reverberation levels are lowered, early reflections are disabled and an extra gain is added to audio from diffraction paths. Now, the user or listener is able to find the interesting audio source in the basement more easily.

In some embodiments the rendering modification can be user (or listener) position dependent. In some embodiments the rendering modification can furthermore be dependent on some other condition, for example, rendering modifications could be applied on audio elements located in the same acoustic environment as the user or within a certain threshold.

In some embodiments the rendering modes are specified in a data neutral or data non-neutral manner. Consequently, some modes may result in additional data to be delivered to the playback device if they are data non-neutral rendering modes.

Thus in some embodiments the concept can be summarised as a method, comprising: generating a bitstream defining a six degrees of freedom audio rendering presentation, the presentation comprising a six degrees of freedom audio scene; and indicating in the bitstream a definition for a rendering mode, where the rendering mode can be interactively selected, to perform the six degrees of freedom audio scene rendering in accordance with the selected rendering mode, where the rendering mode description in the bitstream defining the six degrees of freedom audio scene rendering is modified by at least one parameter compared to the six degrees of freedom audio scene rendering metadata in the bitstream when the rendering mode is not selected; wherein the rendering mode definition comprises at least one rendering parameter information for the six degrees of freedom audio scene rendering with the interactively selected rendering mode.

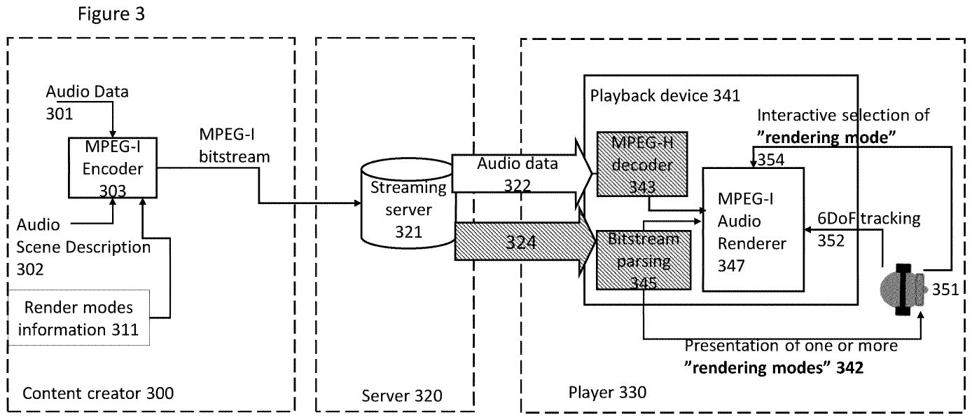

FIG. 3 shows an example system within which apparatus or devices are configured to implement some embodiments. The system of devices or apparatus, the terms device and apparatus within the description being interchangeable, can comprise three components. These can be a content creator 300, storage/streaming server 320 and player 330. Although in the following example the content creator 310 and the storage/streaming server 320 are shown a separate apparatus, in some embodiments the content creator 310 and the storage/streaming server 320 are implemented on the same apparatus or on the same groups of apparatus.

The content creator 300 is configured to write data into a bitstream 310 and transmits the bitstream 310 to the server 320 which can further output data streams, shown as audio data 322 and metadata data 324 to a player 330, which is configured to decode the bitstream, performs processing according to the embodiments and outputs audio for headphone (or other suitable transducer system) listening.

The content creator 300 functionality can, in some embodiments, be implemented as content creator computers and/or network server computers.

The content creator 300 furthermore in some embodiments comprises a render mode information (or render modes information) 311 configured to define one or more modes for rendering the audio scene and furthermore mode rendering modification information or metadata associated with the modes.

In some embodiments the render mode information 311 is provided in an EIF format and passed to a MPEG-I encoder to be converted into a suitable bitstream format. In some embodiments the render mode information 311 is already provided in a suitable bitstream format and added to the rest of the MPEG-I bitstream. An example of this MPEG-I bitstream format is the RenderingModesInformationStruct( ) structure shown here:

aligned(8) RenderingModesInformationStruct( ){

| | | |
|---|---|---|
| unsigned | int(8) | num_RenderingModes;//rendering modes |

for(i=0;i<num_RenderingModes;i++){

| | | |
|---|---|---|
| unsigned | int(8) | RenderingModeType; |

```
if(RenderingModeType==0)
  AbsoluteRenderingModeStruct( );
if(RenderingModeType==1)
  AdditiveRenderingModeStruct( );
if(RenderingModeType==2)
  ModifyingRenderingModeStruct( );
```

```
    }
  }
```

In this example the rendering mode types can be defined as:

| Value | Semantics and data structure |
|---|---|
| 0 | Rendering parameters specified in the |
| | AbsoluteRenderingModeStruct ( ) are applied. All the other |
| | parameters in the renderer defaults or bitstream are discarded. |
| 1 | Rendering parameters specified in the |
| | AdditiveRenderingModeStruct ( ) are applied if they are not |
| | already set via the rendering parameters in the bitstream or the |
| | renderer defaults. |
| 2 | Rendering parameters specified in the |
| | ModifyingRenderingModeStruct ( ) are applied only to the |
| | rendering parameters in the bitstream or the renderer defaults. |
| 4 | Dialog mode reduces reverberation rendering by setting the reverb |
| | to inactive. |
| 5 | Enhance localization by disabling early reflections |
| 6 | CustomRenderindModeStruct ( ) is a rendering mode where |
| | each parameter can carry its own signaling for how it should be |
| | applied (over-ride, only modify if set, only use this parameter and |
| | deactivate every other rendering parameters) by the renderer. |
| 7-255 | Reserved |

The data carried by the structures AdditiveRenderingModeStruct( ), AdditiveRenderingModeStruct( ), AdditiveRenderingModeStruct( ) and CustomRenderingModeStruct( ) is the same. The last one carries additional signaling. This for example can be, as described below, indicated as RenderingModeStructTemplate( ).

```
  aligned(8) RenderingModeTemplateStruct( ){
  unsigned int(8) num_RenderingParameters;//rendering
parameters
  for(i=0;i<num_RenderingParameters;i++){
    unsigned int(2) LateReverbEffectMode;
    if(LateReverbEffectMode!=0)
      ReverbPayloadStruct( );
    unsigned int(2) EREffectMode;
    if(EREffectMode!=0)
      ERGainStruct( );
    unsigned int(1) DisableOcclusionModeFlag;
    unsigned int(1) DisableDiffractionModeFlag;
    unsigned int(1) DisableHeteroExtentModeFlag;
    unsigned int(1) DisableHomoExtentModeFlag;
    unsigned int(1) DisablePortalsModeFlag;
    unsigned int(2) DistancegainEffectMode;
    if(DistanceGainEffectMode!=0)
      DistanceGainChangeStruct( );
    unsigned int(1) DopplerEffectModeFlag;
    bit(3) reserved = 0;
  }
}
```

The parameters LateReverbEffectMode, EREffectMode, DistancegainEffectMode can have different values where each value carries a different semantics. The late reverb change LateReverbEffectMode (enhancement or attenuation) requires a new reverb payload structure to ensure appropriate parameters are available with the renderer. In case of EREffectMode enhancement or attenuation a positive or negative gain value is signalled in the ERGainStruct( ). Similarly, in case of DistanceGainEffectMode enhancement or attenuation a new distance for halving the gain is signalled.

| Value | Semantics |
|---|---|
| 0 | Disable effect |
| 1 | Attenuate effect |
| 2 | Enhance effect |
| 3 | Reserved |

In some embodiments any suitable format for defining the rendering modes is used. For example, as described above, in some embodiments the render mode informations are defined in an EIF format. An example of which is shown here

<RenderMode>
Declares a render mode. The render mode describes modifications to the scene or a rendering aspect of the renderer.

| Child node | Count | | | |
|---|---|---|---|---|
| <StageConfig> | >=0 | <RenderingParameter> see below | | |
| <Modify> | >=0 | <Modify> see below | | |
| Attribute | Type | Flags | Default | Description |
| id | ID | R | | Identifier |

<StageConfig>
Declares a configuration for rendering aspects of the renderer.

| Attribute | Type | Flags | Default | Description |
|---|---|---|---|---|
| id | ID | R | | Identifier |
| stage | String | R | | Affected stage |
| active | Boolean | O | True | Stage active or not |
| gainDb | gain | O | 0 | Gain (dB) |

### EXAMPLE 1

```
// define the dialogue rendering mode (disable reverb, early
reflections and diffraction stages)
<RenderMode id=“rm:dialogue_mode” >
  <StageConfig id=“rp:disable_reverb” stage=“Reverb”
active=False/>
  <StageConfig id=“rp:disable_ER” stage=“EarlyReflections”
active=False/>
  <StageConfig id=“rp:disable_diffraction” stage=“Diffraction”
active=False/>
</RenderMode>
```

### EXAMPLE 2

```
// set new rto60 values for an acoustic environment (AE1) when
“immersive mode” is selected
<RenderMode id=“rm:immersive_mode”>
  <Modify id=“AE1_Frequency1” RT60=“1.0” />
  <Modify id=“AE1_Frequency2” RT60=“1.2” />
  <Modify id=“AE1_Frequency3” RT60=“0.9” />
  <Modify id=“AE1_Frequency4” RT60=“0.6” />
</RenderMode>
<AcousticEnvironment id=“AE1”>
  <AcousticParameters>
    <Frequency id=“AE1_Frequency1” RT60=“0.5” ddr=“0.3”/>
    <Frequency id=“AE1_Frequency2” RT60=“0.6” ddr=“0.3”/>
    <Frequency id=“AE1_Frequency3” RT60=“0.3” ddr=“0.3”/>
    <Frequency id=“AE1_Frequency4” RT60=“0.2” ddr=“0.3”/>
  </AcousticParameters>
</AcousticEnvironment>
```

This render mode information can then be passed to a MPEG-I encoder 303.

The content creator 300 in some embodiments comprises an MPEG-I encoder 303. The MPEG-I encoder 303 is configured to receive the render mode information 311, audio scene description 302 information and the audio data (or audio signals) 301.

As described above the MPEG-I encoder 303 can be configured to receive the render mode information 311 in an EIF format and convert it into a suitable MPEG-I bitstream format such as described above, or receive the render mode information 311 in a bitstream format and then append, combine or otherwise this information to the other bitstream components.

In some embodiments the audio scene description 302 can be provided in the MPEG-I Encoder Input Format (EIF) or in other suitable format. Generally, the audio scene description contains an acoustically relevant description of the contents of the audio scene, and contains, for example, the scene geometry as a mesh or a voxel representation, acoustic materials, acoustic environments with reverberation parameters, positions of sound sources, and other sound source related parameters, for example sound source directionality.

Furthermore the audio data (or audio signals) 301 can be provided in any suitable format. For example in some embodiments the audio data is provided as audio signals associated with each sound source and one or more ambient audio signals.

In some embodiments any suitable ‘6DoF’ immersive audio encoder other than a MPEG-I encoder can be employed provided it is configured to generate encoded data for encoding suitable audio signals and information defining the audio scene.

The output of the MPEG-I encoder 303, the MPEG-I bitstream can then in some embodiments be provided to a streaming server 321 (implemented on server 320).

The MPEG-I encoder in some embodiments can output the encoded data as audio scene information packet together with the scene payload or configuration packet. Furthermore these can also be delivered as a user interaction input during runtime.

The server 320 in some embodiments comprises a streaming server 321 configured to receive the bitstream from the content creator 300 and furthermore be configured to send to a player 320 encoded audio data 322 and the encoded metadata (the audio scene description information and the render mode information) 324.

The output of the streaming server 321 can thus be passed to the player 330.

The player 330 can comprise a playback device 341 and head-mounted device (HMD) 351.

The playback device 341 is configured to obtain the audio data 322, the metadata bitstream 324 from the streaming server 321 and furthermore generate outputs for the head-mounted device 351. Furthermore the head-mounted device can be configured in some embodiments to generate suitable data such as a mode selection information and 6DoF tracking information to assist the playback device 341 to generate the outputs for the head-mounted device 351.

The playback device 341 can be a mobile device, personal computer, sound bar, tablet computer, car media system, home HiFi or theatre system, head mounted display for AR or VR, smart watch, or any suitable system for audio consumption.

In some embodiments the playback device 341 comprises a bitstream parser (decoder) 345 configured to receive, parse (and decode) the bitstream 324. For example the audio scene information is passed to a MPEG-I Audio renderer 347 and the render mode information is passed to the head-mounted device 351.

The playback device 341 further can comprise a suitable audio signal decoder. In the example shown in FIG. 3 the audio signal decoder is a MPEG-H decoder 343 which is configured to output the decoded audio signals to the MPEG-I audio renderer 347.

reverberation payload decoder 1953 configured to obtain the encoded reverberation parameters and decode these in an opposite or inverse operation to the reverberation payload encoder 1913.

In some embodiments the playback device comprises a suitable renderer, for example is shown a MPEG-I audio renderer 347. In this example the MPEG-I audio renderer 347 is configured to obtain the decoded audio signals and the audio scene metadata. The MPEG-I audio renderer 347 can then be configured to generate audio signals for the head mounted device 351 based on the decoded audio signals and the audio scene metadata.

Additionally the MPEG-I audio renderer 347 is configured to obtain from the head-mounted device 351 a selection of the rendering mode 354. In this example the selection is provided from the HMD 351, however in some embodiments there may be other apparatus or devices which receive the rendering mode information and then provide the selection information.

In some embodiments the selection information comprises the modification information. However in some other embodiments the selection information comprises a selection indicator for selecting the mode and the renderer 347 is configured to receive information defining the rendering modification to be implemented when a specific mode has been selected.

Furthermore in some embodiments HMD 351 is configured to provide 6DoF tracking information 351 to the MPEG-I audio renderer 347. The MPEG-I audio renderer 347 can thus further modify the rendered output based on the tracking information.

In other words, based on the available modes (stored in renderer implementation on the user device or from bitstream), the player 330 makes available for user selection the list of modes. The user (HMD 351) may then select a mode. The mode selection causes the modification of rendering parameters and potentially scene state representation. The rendering stages may be added, modified or deleted in the rendering pipeline. The player reinitializes the renderer with the new parameters according to the mode based rendering modification instructions.

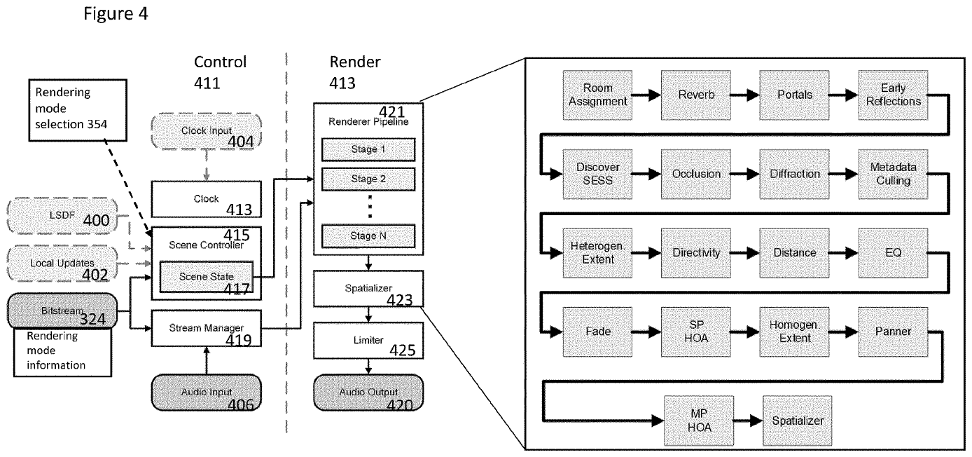

FIG. 4 furthermore shows the example MPEG-I renderer 347 in further detail according to some embodiments. The renderer 347 in this example is shown with a control processing 411 and render processing 413 parts.

The control processing 411 in some embodiments comprises a stream manager 419. The stream manager 419 is configured to receive the bitstream comprising the rendering mode information 324 and furthermore the audio input 406 and direct this to the renderer pipeline 421 of the render processing 413.

Additionally the control processing 411 comprises a scene controller 415 and scene state definer 417. The scene controller 415 is configured to obtain the bitstream comprising the rendering mode information 324, the rendering mode selection information 354 and optionally listening space description format (LSDF) information 400 and local updates 402 and define a scene state which is signalled to the renderer pipeline 421.

Furthermore is shown in the control processing 411 a clock 413 configured to receive a clock input and configured to control the synchronisation of the processing.

The render processing 413 can comprise a renderer pipeline 421 configured to implement rendering of the audio signals based on the selected modes.

The renderer pipeline 421 can comprise a number of sub-stages each configured to implement an element of the rendering of the output audio signals. These can, for example, comprise the stages of: room assignment; reverberation; portals; early reflections; discover SESS; occlusion; diffraction; metadata culling; heterogeneous extent; directivity; distance; equalization; fading; SP HOA (Single Point HOA); homogeneous extent; panning; and MP HOA (Multi-Point HOA).

Additionally the output of the pipeline can be passed to a spatializer 423.

The output of the spatializer 423 can be passed to the limiter 425 and then output 420.

Thus in summary the rendering mode directives 324 (the rendering mode information) are provided along with the bitstream to a Scene Controller 415. Also the user selected rendering mode indication 354 is provided to the Scene Controller 415. The Scene Controller 415 takes this information (along with the other scene information) and configures the Scene State. The Scene State is then provided to different Render Stages which in turn employ processing according to the Scene State. Whenever the user selects a new render mode, the Scene Controller reconfigures the Scene State according to the mode selection and mode directives. Depending on the Scene State, the behaviour of the render stages are changed. In some cases, a whole rendering stage may be disabled.

An example of this processing operation can be shown based on the example audio scene shown in FIG. 1. In this example the HMD (user) selects a “dialogue mode” from a provided user interface (UI). Information on the selected mode is provided to the Scene Controller. The Scene Controller can then configure the Scene State such that all audio sources have a “noreverb” flag enabled such that all audio sources are excluded from reverberation processing. The “noreverb” flag is described as a renderer control parameter in the Encoder Input Format (as described in N0054, MPEG-I Immersive Audio Encoder Input Format). This in some embodiments can be implemented by causing the Reverb Stage to be skipped for all audio sources. Alternatively the “noreverb” flag can be implemented by a negative gain applied to the output of the Reverb Stage.

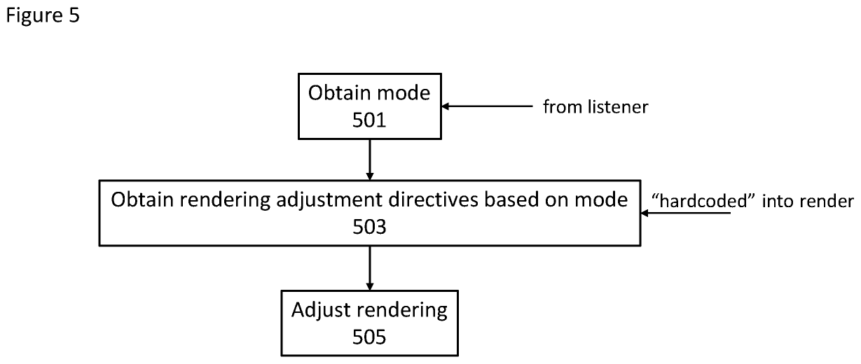

With respect to FIG. 5 is shown a flow diagram of the operation of some embodiments from the point of view of the renderer or playback device. In these examples the encoder is not configured to supply the mode information from the streamed bitstream (as it is predetermined or hardcoded within the renderer). Thus all the options for the rendering modes are already built into the renderer implementation. The functionality can be summarized in the following steps.

A first operation is one of obtaining the mode (from a predetermined set of possible modes) from the listener as shown by 501. The user interface can in some embodiments comprise a list of modes declared to the (listener) end user. The list of modes can be a two value pair, comprising a unique identifier for the particular rendering mode and a textual description. The rendering mode text can be appropriately localized. The rendering mode may be selected by the user using his VR player app UI on the HMD from a predefined set of rendering modes. The set of rendering modes can be provided to the VR player app by the renderer and the VR player app provides the selected mode to the renderer. In the example implementation this step is performed inside the playback device. The renderer provides the player UI with a list of rendering modes, which the user selects from. The selection is then passed back to the renderer.

Then ‘hardcoded’ on the playback device (or generally predefined on the playback device) the rendering adjustments are obtained as shown by 503. In other words based on the rendering mode, the renderer obtains rendering modification directives. The rendering modification directives are stored in the renderer for each rendering mode. The rendering mode directives for a rendering mode may be a list of directives controlling different rendering aspects. Some examples include, but are not limited to:
Disable reverb/modify reverb gain
Disable early reflections
Lower distance gain attenuation
Disable occlusion

In the example MPEG-I Audio renderer the Scene Controller block holds the rendering mode adjustment directives information. This can be in the format of a table which contains a list of rendering adjustments for each rendering mode.

Then based on the rendering adjustments caused by the obtained mode the rendering is adjusted as shown by 505. The renderer is re-initialized to start rendering according to the selected rendering mode by modifying the rendering parameters according to the retrieved list of rendering modifications, in accordance with the selected rendering mode. The Scene controller block modifies the Scene state according to the rendering parameter adjustment directives for the selected rendering mode. This causes changes in the rendering pipeline. Stages may be disabled altogether or their rendering is modified (depending on the rendering directives for the selected rendering mode).

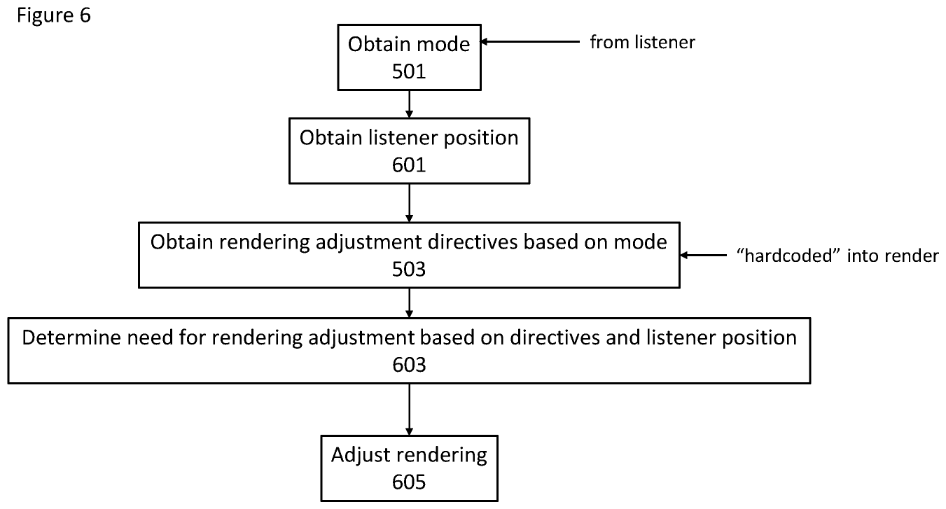

With respect to FIG. 6 is shown a modification to the example flow diagram of FIG. 5.

A first operation is one of obtaining the mode (from a predetermined set of possible modes) from the listener as shown by 501.

Additionally the listener position and/or orientation are obtained as shown by 601. These listener position and/or orientation can be obtained from the HMD.

Then ‘hardcoded’ on the playback device (or generally predefined on the playback device) the rendering adjustments are obtained as shown by 503.

A rendering adjustment operation determination can then be performed wherein there is a check or determination of a need to perform rendering adjustment based on the directives and the listener position as shown by 603. In this example the rendering adjustment directives are user position dependent. For example, audio sources which are positioned in some other Acoustic environment (room) than the user is currently in, are not modified. This can be performed in the renderer. The scene controller can thus be aware of the listener position and adjusts the scene state accordingly.

Then based on the check or determination of whether rendering adjustments are to be made then the rendering is adjusted as shown by 605.

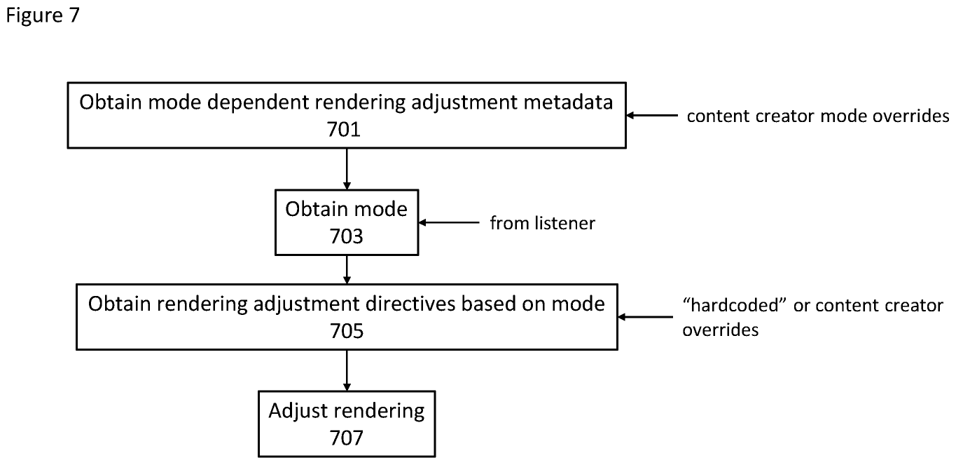

With respect to FIG. 7 is shown a flow diagram of the operation of some embodiments from the point of view of the renderer or playback device. In these examples the encoder is configured to supply the mode information from the streamed bitstream (as it is predetermined or hardcoded within the renderer), such as shown by the example shown in FIG. 3.

A first operation is one of obtaining the mode dependent rendering adjustment metadata from the content creator (from a predetermined set of possible modes) from the listener as shown by 701.

The metadata is delivered to the renderer in the content bitstream along with the other 6DoF rendering metadata. In some embodiments, the rendering mode modification metadata can be delivered separately via other out-of-band delivery methods. The content creator created modifications may contain rendering modifications for rendering modes for which rendering modification information is not present in the renderer or they may contain “overrides” for the modifications stored in the renderer.

As shown in FIG. 3 the rendering adjustment metadata is received at the renderer from the server. The bitstream is then parsed and rendering adjustment directives are stored in the renderer in the Scene controller.

Two examples of content creator created overrides are shown below.

```
<ModeUpdate id=“upd:dialogue_mode” mode=“dialogue_mode”
index=“0”>
  <Modify component=“REVERB” active=“false”/>
  <Modify component=“EARLY_REFLECTIONS” active=“false”/>
  </ModeUpdate>
```

In this example the content creator rendering mode provides an override in MPEG-I Audio Encoder Input File (EIF)-like format. The content creator (such as shown in FIG. 3) can by providing render mode information be configured to control or influence the rendering in a specific mode. In this example there is defined a dialogue mode, which enables the renderer to control the rendering of the audio signal such that reverberation and early reflection processing is deactivated. These instructions are used instead of any built-in or default rendering modifications. In some embodiments the above described mode description can be transformed into the bitstream format for the 6DoF bitstream by the MPEG-I encoder 303.

```
<ObjectSource id=“obj:speaker1” index=“0” type=“dialogue”/>
<ObjectSource id=“obj:speaker2” index=“1” type=“dialogue”/>
<ObjectSource id=“obj:car” index=“2” type=“ambience”/>
<ModeUpdate id=“upd:dialogue_mode” mode=“dialogue_mode”
index=“0”>
  <Modify id_type=“dialogue” noreverb=“true”/>
  <Modify id_type=“ambience” noreverb=“true”/>
  <Modify id_type=“ambience” gainDb=“−6”/>
</ModeUpdate>
```

In the above example the content creator rendering mode override is also provided in a MPEG-I Audio Encoder Input File (EIF)-like format. The content creator in this example has set some <ObjectSource> elements to have a type (“dialogue” or “ambience”). Furthermore in this example there are defined instructions to disable reverb processing for “dialogue” and “ambience” elements and also to lower the gain of the “ambience” elements.

The mode can then be obtained as shown in 703. The mode can be obtained in a manner similar to that above in that the user interface can in some embodiments comprise a list of modes declared to the (listener) end user. The rendering mode may be selected by the user using his VR player app UI on the HMD from a predefined set of rendering modes. The set of rendering modes can be provided to the VR player app by the renderer and the VR player app provides the selected mode to the renderer. The selection is then passed back to the renderer.

Then rendering adjustment directives or controls based on the mode can be determined (based on either the hardcoded or content creator override controls) as shown by 705. In other words based on the rendering mode, the renderer obtains rendering modification directives or controls.

Then based on the rendering adjustments caused by the obtained mode the rendering is adjusted as shown by 707. The renderer is re-initialized to start rendering according to the selected rendering mode by modifying the rendering parameters according to the retrieved list of rendering modifications, in accordance with the selected rendering mode. The Scene controller block modifies the Scene state according to the rendering parameter adjustment directives for the selected rendering mode. This causes changes in the rendering pipeline. Stages may be disabled altogether or their rendering is modified (depending on the rendering directives for the selected rendering mode).

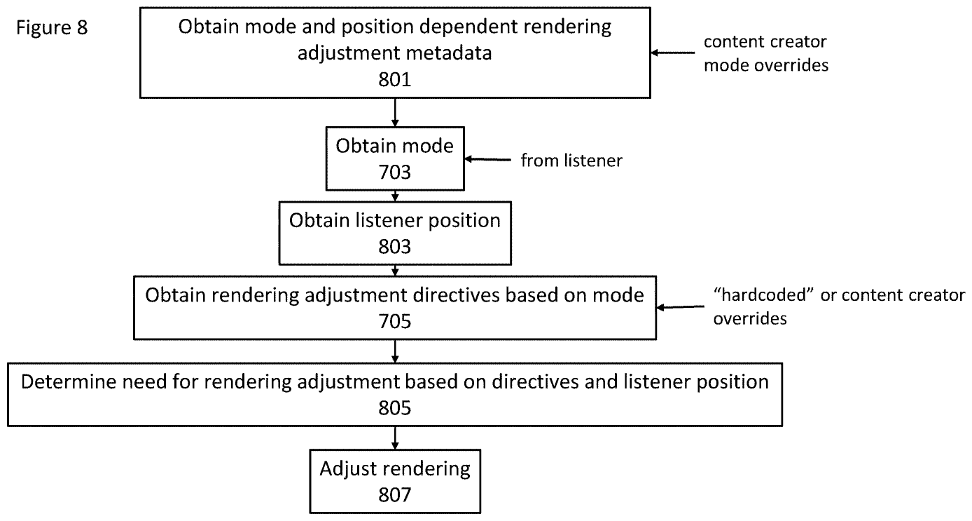

With respect to FIG. 8 is shown a further embodiment or example with a modification to the example flow diagram of FIG. 7.

A first operation is one of obtaining the mode and position dependent rendering adjustment metadata from the content creator (from a predetermined set of possible modes) from the listener as shown by 801.

Following on a further operation is obtaining the mode (from a predetermined set of possible modes) from the listener as shown by 703.

Then rendering adjustment directives or controls based on the mode can be determined (based on either the hardcoded or content creator override controls) as shown by 705. In other words based on the rendering mode, the renderer obtains rendering modification directives or controls.

A rendering adjustment operation determination can then be performed wherein there is a check or determination of a need to perform rendering adjustment based on the directives and the listener position as shown by 805. In this example the rendering adjustment directives are user position dependent. For example, audio sources which are positioned in some other Acoustic environment (room) than the user is currently in, are not modified. This can be performed in the renderer. The scene controller can thus be aware of the listener position and adjusts the scene state accordingly.

Then based on the check or determination of whether rendering adjustments are to be made then the rendering is adjusted as shown by 807.

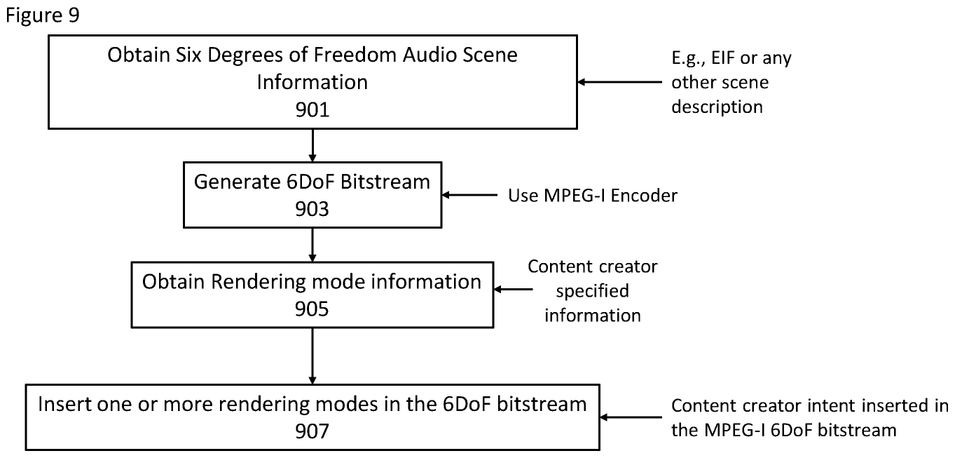

With respect to FIG. 9 is shown an example flow diagram showing the operation of the content creator shown in FIG. 3.

The content creator can thus obtain six degrees of freedom audio scene information as shown by 901. This as described herein can be in an EIF or other scene description format.

Then in some embodiments the 6DoF bitstream is generated as shown by 903.

Furthermore the rendering mode information is obtained as shown by 905.

Then the one or more rendering modes are inserted into the 6DoF bitstream as shown by 907.

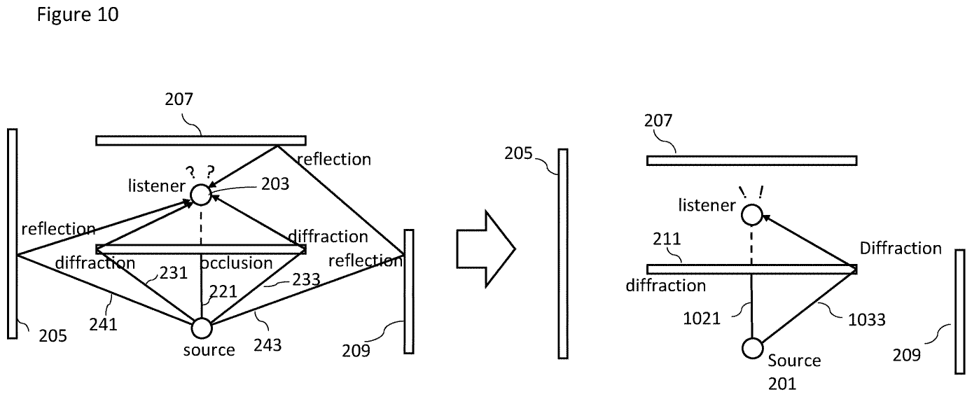

With respect to FIG. 10 is shown the operation of a “navigation mode” or “localization mode” in an example such as shown in FIG. 2. In this example as described earlier the listener is experiencing a 6DoF audio scene. The scene is a large house where there is something interesting (an audio source) in the basement. The user is not quite sure where the sound is coming from and selects a “navigation mode”. The content creator, during scene creation, has created controls or directives which define how the renderer should act in the navigation mode and added metadata describing that in the navigation mode, reverb levels are lowered, early reflections are disabled and an extra gain is added to audio from diffraction paths. Thus the listener is able to find the interesting thing in the basement easily as the ‘loudest’ path from the source 201 to the listener is via the diffraction path 1033.

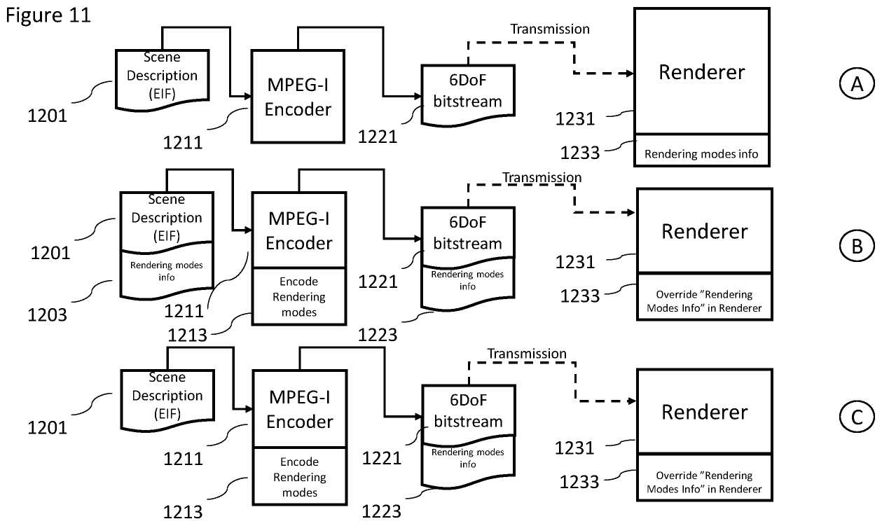

With respect to FIG. 11 is shown schematically example embodiments for generating and employing the rendering modes of the implementations described above:
The first example embodiment A shows the scenario where the 6DoF bitstream is generated based on the scene description 1201 by the MPEG-I encoder 1211 to generate the 6DoF bitstream 1221 for rendering the 6DoF audio scene. The renderer 1231 in this example carries rendering mode information 1233. Thus, in this implementation there is also a possibility to have rendering mode support without carrying any additional information in the 6DoF bitstream.

The second example embodiment B shows the scenario where the rendering mode information 1203 is provided along with the audio scene description 1201 to the enhanced MPEG-I encoder 1211 (with rendering mode encoder 1213) to deliver the 6DoF bitstream 1221 with rendering mode info 1223 for rendering the 6DoF audio scene. This bitstream information can be used by the renderer 1231 to perform the rendering mode functionality described herein. In some embodiments if the renderer comprises (already) some information for rendering modes, the bitstream carried rendering modes can be configured to, for example, override the renderer rendering mode information (parameters) 1233.

The third example embodiment C shows the scenario where the rendering modes information 1213 is derived by the MPEG-I encoder 1211 based on the scene description 1201. In some embodiments the scenarios B and C can coexist.

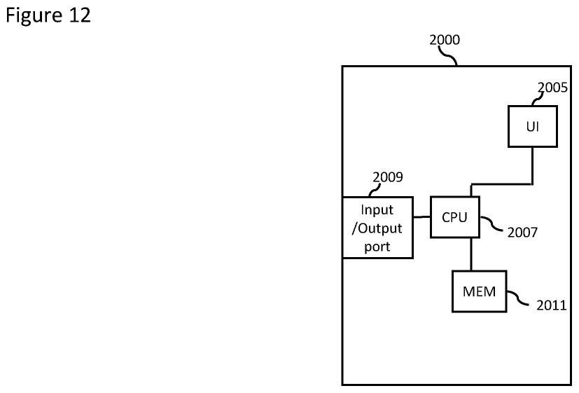

With respect to FIG. 12 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device. The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method, comprising:
obtaining a bitstream configured to define a six-degrees of freedom rendering, the bitstream comprising a six degrees of freedom audio scene;
obtaining information configured to define at least one rendering modification parameter;
rendering the bitstream to generate at least two output audio signals, wherein the rendering is configured to be modified based on the at least one rendering modification parameter; and
controlling the outputting based on the at least two output audio signals using the at least one rendering modification parameter.

2. The method as claimed in claim 1, wherein the information comprising at least one rendering modification to be applied with a renderer when rendering an output audio signal from the six degrees of freedom audio stream when at least one rendering mode is selected at the renderer comprises the at least one rendering modification parameter, the at least one rendering modification parameter being configured to control a modification of at least one rendering process at the renderer.

3. The method as claimed in claim 2, wherein the at least one rendering modification parameter is further configured to control a modification of at least one default rendering process at the renderer, wherein the default rendering process is applied with the renderer when rendering of the six degrees of freedom audio scene when the at least one rendering mode is not selected.

4. The method as claimed in claim 2, wherein the at least one rendering modification parameter comprises at least one of:
a reverberation modification configured to selectively enable reverberation for at least one audio source within the six degrees of freedom audio scene;
a reflections modification configured to selectively enable reflections for at least one audio source within the six degrees of freedom audio scene;
an occlusion modification configured to selectively enable occlusions for at least one audio source within the six degrees of freedom audio scene;
a diffraction modification configured to selectively enable diffraction for at least one audio source within the six degrees of freedom audio scene;
a heterogenous extent modification configured to selectively enable heterogenous propagation for at least one audio source within the six degrees of freedom audio scene;
a homogenous extent modification configured to selectively enable homogenous propagation for at least one audio source within the six degrees of freedom audio scene;
a portals modification configured to selectively enable portals for at least one audio source within the six degrees of freedom audio scene;
a distance gain modification configured to selectively enable distance gains for at least one audio source within the six degrees of freedom audio scene; or
a doppler modification configured to selectively enable doppler effects for at least one audio source within the six degrees of freedom audio scene.

5. The method as claimed in claim 4, wherein the at least one rendering modification parameter comprises at least one of:
a disable effect modification configured to disable at least one rendering process;
an attenuate effect modification configured to attenuate at least one rendering process; or
an enhance effect modification configured to enhance at least one rendering process.

6. The method as claimed in claim 1, wherein the bitstream configured to define the six-degrees of freedom rendering comprises at least one of:
receiving the information in an encoder input file format and generating an encoded MPEG-I format bitstream to be combined with an encoded six degrees of freedom audio scene bitstream; or
obtaining the information in an MPEG-I format and combining the information with an encoded six degrees of freedom audio scene bitstream.

7. A method, comprising:
obtaining a bitstream configured to define a six-degrees of freedom rendering, the bitstream comprising a six degrees of freedom audio scene;
obtaining information configured to define at least one rendering mode, the information comprising:
an identifier configured to identify the at least one rendering mode; and
at least one rendering modification associated with the at least one rendering mode;
obtaining information identifying a desired rendering mode;
rendering the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and
controlling the outputting of the at least two output audio signals.

8. The method as claimed in claim 7, wherein the information comprising the at least one rendering modification associated with the at least one rendering mode comprises at least one modification parameter, wherein rendering the bitstream to generate at least two output audio signals from the bitstream comprises rendering the bitstream based on the at least one modification parameter controlling a modification of at least one rendering process.

9. The method as claimed in claim 8, wherein the at least one modification parameter is configured to control a modification of at least one default rendering process, wherein rendering the bitstream to generate at least two output audio signals from the bitstream configured to define a six-degrees of freedom audio rendering comprises rendering the bitstream with applying the default rendering process when the at least one rendering mode is not selected.

10. The method as claimed in claim 9, further comprising:
determining the default rendering process based on:
the bitstream configured to define a six-degrees of freedom rendering; and
at least one renderer defined value.

11. The method as claimed in claim 8, wherein the at least one modification parameter comprises at least one of:
a reverberation modification configured to selectively enable reverberation for at least one audio source within the six degrees of freedom audio scene;
a reflections modification configured to selectively enable reflections for at least one audio source within the six degrees of freedom audio scene;
an occlusion modification configured to selectively enable occlusions for at least one audio source within the six degrees of freedom audio scene;
a diffraction modification configured to selectively enable diffraction for at least one audio source within the six degrees of freedom audio scene;
a heterogenous extent modification configured to selectively enable heterogenous propagation for at least one audio source within the six degrees of freedom audio scene;
a homogenous extent modification configured to selectively enable homogenous propagation for at least one audio source within the six degrees of freedom audio scene;
a portals modification configured to selectively enable portals for at least one audio source within the six degrees of freedom audio scene;
a distance gain modification configured to selectively enable distance gains for at least one audio source within the six degrees of freedom audio scene; or
a doppler modification configured to selectively enable doppler effects for at least one audio source within the six degrees of freedom audio scene.

12. The method as claimed in claim 11, wherein the at least one modification parameter comprises at least one of:
a disable effect modification configured to disable at least one rendering process;
an attenuate effect modification configured to attenuate at least one rendering process; or
an enhance effect modification configured to enhance at least one rendering process.

13. The method as claimed in claim 7, wherein obtaining information configured to define at least one rendering mode comprises obtaining at least one predetermined information prior to the obtaining of the bitstream.

14. The method as claimed in claim 13, wherein obtaining information configured to define at least one rendering mode comprises receiving at least one further at least one information configured to define at least one rendering mode, wherein the received at least one further at least one information configured to define at least one rendering mode supersedes the at least one predetermined information configured to define at least one rendering mode.

15. The method as claimed in claim 7, wherein the bitstream further comprises the information configured to define the at least one rendering mode wherein obtaining information configured to define at least one rendering mode comprises obtaining the information from the bitstream.

16. The method as claimed in claim 7, wherein the information configured to define the at least one rendering mode is in an encoder input format.

17. The method as claimed in claim 7, wherein obtaining information identifying a desired rendering mode comprises obtaining an input from a user interface identifying the desired rendering mode.

18-19. (canceled)

20. An apparatus, comprising:
at least one processor; and
at least one memory storing instructions that, when executed with the at least one processor, cause the apparatus at least to:
generate a bitstream configured to define a six-degrees of freedom rendering, the bitstream comprising:
a six degrees of freedom audio scene; and
information configured to define at least one rendering mode, the information comprising:
an identifier configured to identify the at least one rendering mode; and
at least one rendering modification associated with the at least one rendering mode to be applied with a renderer when rendering the six degrees of freedom audio scene when the at least one rendering mode is selected at the renderer.

21. An apparatus, comprising:
at least one processor; and
at least one memory storing instructions that, when executed with the at least one processor, cause the apparatus at least to:
obtain a bitstream configured to define a six-degrees of freedom rendering, the bitstream comprising a six degrees of freedom audio scene;
obtain information configured to define at least one rendering mode, the information comprising:
an identifier configured to identify the at least one rendering mode; and
at least one rendering modification associated with the at least one rendering mode;
obtain information identifying a desired rendering mode;
render the bitstream to generate at least two output audio signals from the bitstream configured to define a six-degrees of freedom audio rendering, wherein the rendering is modified based on the at least one rendering modification associated with a selected one of the at least one rendering mode, the selected one of the at least one rendering mode being selected based on the information identifying the desired rendering mode; and
control the outputting of the at least two output audio signals.

22. The method as claimed in claim 1, wherein obtaining the bitstream comprises generating the bitstream configured to define the six-degrees of freedom rendering.
